(19) United States
(12) Patent Application Publication
(10) Pub. No.: US 2024/0178630 A1
(43) Pub. Date: May 30, 2024

(54) Amplified Spontaneous Emission Source Operational In Two Micron Wavelength Region

(71) Applicant: Cybel, LLC., Bethlehem, PA (US)

(72) Inventors: Wiktor Tomasz Walasik, Bethlehem, PA (US); Jean-Marc Pierre Delavaux, Pittstown, NJ (US); Alexandre Amavigan, Whitehall, PA (US)

(73) Assignee: Cybel, LLC., Bethlehem, PA (US)

(21) Appl. No.: 18/071,880

(22) Filed: Nov. 30, 2022

(51) Int. Cl. H01S 3/094; H01S 3/00; H01S 3/067; H01S 3/106; H01S 3/16

(52) U.S. Cl. CPC H01S 3/094011; H01S 3/0064; H01S 3/06716; H01S 3/06733; H01S 3/094042; H01S 3/106; H01S 3/1608; H01S 3/161; H01S 3/1616; H01S 3/1618; H01S 2301/02

(57) ABSTRACT

A high-power ASE source in the 2 μm wavelength band is achieved by using a relatively high-power pump beam that is generated within a fiber laser-based pump source. An optical isolator is included along the pump output path and is critical in maximizing the level of output power in the generated ASE, since without its use the ASE source begins to exhibit self-lasing cavity modes at a relatively low power level. Various embodiments of the present invention are based upon the use of a two-stage (or more) arrangement for generating a high-power ASE output, including an ASE-generating stage for establishing the broadband ASE spectrum and an amplifier stage for increasing the optical power within the ASE spectrum. The amplifier stage itself may include one or more individual amplifying elements in a concatenated arrangement. Optical isolators are included along the signal paths to prevent the type of reflections that would otherwise trigger self lasing.

### TECHNICAL FIELD

The present invention relates to the provision of a broadband source of amplified spontaneous emission (ASE) and, more particularly to a high-power ASE source with an emission spectrum within the eye-safe 2 μm region of light.

### BACKGROUND

Conventional ASE sources are well-known in the art and are used in a variety of different applications that require broadband, low coherence optical sources. One type of ASE source may use a section of rare-earth-doped optical fiber (typically an erbium-doped fiber (EDF)) with a pump beam of a suitable wavelength applied as an input to the EDF. In the absence of an applied data/communication optical input signal, the presence of the propagating pump beam within the EDF triggers the generation of spontaneous emission, which is thereafter amplified as it propagates along the section of EDF.

While this type of device is suitable for many applications, those that are required to operate in the eye-safe regime of the 2 μm region (typically defined as extending across the wavelength range from about 1700 nm to 2200 nm, for example) require a rare-earth dopant other than erbium to produce ASE. Dopants such as Thulium (Tm), Holmium (Ho), or Tm-Ho are better-suited for generating ASE in the 2 μm wavelength region. To date, however, the amount of optical output power that these Ho-based or Tm-based ASE sources have been able to generate has been very limited, which thus restricts their use in various applications, such as optical component characterization, infrared illumination, or spectrum slicing source, to name a few.

### SUMMARY OF THE INVENTION

The needs remaining in the art are addressed by the present invention, which relates to the provision of a broadband source of amplified spontaneous emission (ASE) and, more particularly to a high-power ASE source with a spectrum within the 2 μm region of light. As discussed in detail below, various embodiments of the present invention are capable of delivering hundreds of milliwatts of output power (up to Watts of power in some wavelength bands) in the 2 μm wavelength region.

In accordance with the principles of the present invention, a high-power ASE source in the 2 μm wavelength band is achieved by using a relatively high-power pump beam that is generated within a fiber laser-based pump source. The inclusion of an optical isolator along the pump output path is critical in maximizing the level of output power in the generated ASE, since without its use the ASE source begins to exhibit self-lasing cavity modes at a relatively low power level.

Various embodiments of the present invention are based upon the use of a two-stage (or more) arrangement for generating a high-power ASE output, including an ASE-generating stage for establishing the broadband ASE spectrum and an amplifier stage for increasing the optical power within the ASE spectrum. The amplifier stage itself may include one or more individual amplifying elements in a concatenated arrangement.

Embodiments of the present invention may be configured with polarization-maintaining (PM) elements and provide a PM ASE output. Other embodiments may be non-PM, which are less expensive and useful in a variety of applications. In the PM ASE configuration, a polarization-dependent optical isolator may be inserted between the stages to impart a linear polarization state to the generated ASE prior to being introduced into the PM amplifier stage. Such a PM embodiment ensures that the light created in the PM amplifier stage is polarized along only the defined linear polarization axis.

An exemplary embodiment of the present invention may take the form of an ASE source operating within the 2 μm region, and comprising a first section of doped optical fiber (containing a dopant selected from the group consisting of: Tm, Ho, and Tm-Ho), a first pump source coupled to the first section of doped optical fiber and configured to provide a pump beam at a wavelength λ_{P} suitable for generating amplified spontaneous emission within the first section of doped optical fiber, and a pump optical isolator disposed between the first pump source and the first section of doped optical fiber for blocking reflections and preventing self-lasing along the first section of doped optical fiber, permitting the generation of ASE having a high output power.

Yet another embodiment may take the form of a two-stage ASE source, including a first stage for generating ASE as described above, and a second amplifier stage comprising a second section of doped optical fiber and pumped at a suitable wavelength for creating optical power gain to the ASE generated in the first stage.

Other and further embodiments and advantages of the present invention will become apparent during the course of the following discussion and by reference to the accompanying drawings.

### BRIEF DESCRIPTION OF THE DRAWINGS

Turning now to the drawings, where like reference numerals are related to like parts in several views:

FIG. 1 illustrates an exemplary high-power ASE source formed in accordance with the principles of the present invention;

FIG. 2 is a graph of output ASE power as a function of applied pump power for the ASE source of FIG. 1;

FIG. 3 shows a comparison of the ASE spectra emitted along a “forward” direction out of the doped optical fiber and along a “backward” direction out of the same fiber;

FIG. 4 illustrates an exemplary two-stage ASE source formed in accordance with the principles of the present invention, including an initial ASE-generating stage and a following optical amplifier stage for increasing the output power of the generated ASE;

FIG. 5 is a graph of ASE output power as a function of applied pump power, comparing the results of the single-stage ASE source of FIG. 1 to the two-stage ASE source of FIG. 4;

FIG. 6 is a plot comparing the ASE spectra produced by the single stage arrangement of FIG. 1 and the dual-stage arrangement of FIG. 4;

FIG. 7 is a graph showing the development of the ASE spectra as the output power is increased through several levels;

FIG. 8 shows the results of simulations where the length of the doped fiber was changed, illustrating the change in generated ASE spectra as a function of change in doped fiber length;

FIG. 9 contains simulation results similar to those of FIG. 8, but in this case for a gain fiber with a different dopant (here, Ho-doped instead of Tm-doped);

FIG. 10 shows measured results of an exemplary ASE source based on the use of HDF in both stages of a two-stage arrangement similar to that of FIG. 4;

FIG. 11 illustrates an exemplary hybrid two-stage embodiment of the present invention, with an ASE-generating stage comprising a section of Ho-doped fiber and the amplifier stage comprising a section of Tm-doped fiber;

FIG. 12 is a graph of the simulated output ASE spectrum for the hybrid embodiment of FIG. 11;

FIG. 13 illustrates yet another embodiment of the present invention, in this case including a section of unpumped doped fiber between the ASE-generating stage and the amplifier stage, the unpumped doped fiber extending the generated continuum;

FIG. 14 shows an embodiment where a bandpass filter is positioned between the two stages of the ASE source so as to tailor the ASE spectrum as applied as an input to the amplifier stage; and

FIG. 15 is a block diagram of a multi-stage embodiment of the ASE source of the present invention, in this case comprising a single ASE-generating stage and a plurality of separate amplifier stages.

### DETAILED DESCRIPTION

The following exemplary embodiments that will be described in detail all relate to the provision of a high-power ASE source operating in the 2 μm wavelength band. While often referred to as the “2 μm wavelength band” or perhaps “the eye-safe wavelength band (region)” in the following, it is to be understand that the principles of the present invention are based upon the use of Tm-doped and/or Ho-doped optical fiber to create the emission in the presence of a pump beam operating at a useful wavelength for this purpose, typically defining the 2 μm band as extending across the spectral range from 1700 nm to 2200 nm. Thus, the actual ASE spectrum achieved in any particular configuration is based upon these parameters, as well as the length of doped fiber used in the process. Indeed, high-power ASE may be generated within an extended band from about 1700 nm to 2200 nm as function of these parameters.

Additionally, the various embodiments to be described below may utilize either single-clad (SC) doped fiber or double-clad (DC) doped fiber, with some configurations better suited for one type of fiber versus the other (and will be described so accordingly). Either non-PM single mode fiber or PM fiber may be used, the latter required for delivering ASE light with a controlled polarization state. In the following discussion, unless specifically defined as utilizing PM fiber, it may be presumed that a particular embodiment of the present invention may be based upon either non-PM (standard) optical fiber or PM optical fiber.

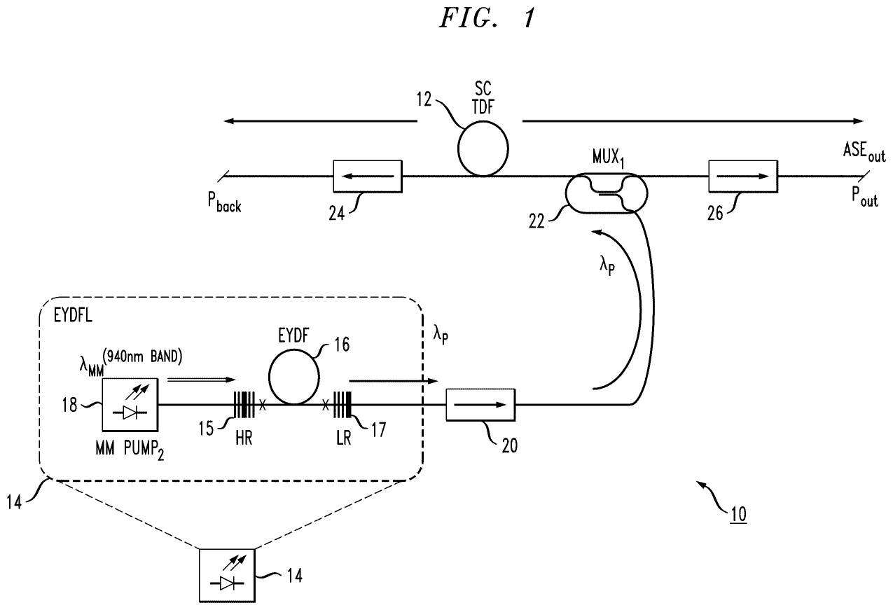

FIG. 1 illustrates an exemplary high-power ASE source 10 formed in accordance with the principles of the present invention. ASE source 10 includes a section of doped optical fiber 12, which in this example comprises a section of single-clad Tm-doped optical fiber (referred to at times hereafter as TDF 12). In order to create spontaneous emission within TDF 12, a pump source operating at a wavelength of about 1550 nm is used, shown in FIG. 1 as pump source 14. In order to provide the necessary high-power pump beam, pump source 14 is shown as comprising a fiber laser pump source (which is known as able of generating pump powers in the range of hundreds of mW to several W). The use of a fiber laser as a pump source may be preferred over the use of a semiconductor laser diode, since the fiber laser does not require any kind of cooling to maintain a stable output wavelength.

In particular, the fiber laser configuration of pump source 14 is shown as including a section of Er—Yb co-doped fiber 16 that is disposed between a pair of reflective elements that define the laser cavity. Here, the pair of reflective elements comprise a high-reflectivity (HR) element 15 and a low-reflectivity (LR) element 17. Both of these elements may take the form of Bragg gratings that are written into sections of optical fiber that are spliced to either end of co-doped fiber 16 (alternatively, the FBGs may be directly written into end regions of co-doped fiber 16). A laser diode 18, in this case operating at a wavelength of 940 nm, is coupled into the pump laser cavity through HR element 15. The presence of this 940 nm light, in conjunction with the matched reflective elements 15 and 17, results in creating a laser resonance at a wavelength around 1500 nm within the cavity, which is defined as the output pump beam P, operating at a wavelength ap. In this case, pump source 14 is formed to create a pump wavelength λₚ of 1567 nm.

Output pump beam P is shown as passing through an optical isolator 20 (referred to at times hereafter as a “pump isolator”) before being applied as an input to a wavelength division multiplexer (WDM) 22 associated with TDF 12. In particular, WDM 22 functions to direct propagating pump beam P into TDF 12 (here, in a counter-propagating direction with respect to the ASE output from source 10). As pump beam P propagates along TDF 12, it triggers spontaneous emission by its interaction with the Tm dopant, where the initially-created spontaneous emission is thereafter amplified within the same fiber to create the ASE output.

The presence of pump isolator 20 allows for an increased level of output power in the generated ASE by preventing an early onset of self lasing. Without using pump isolator 20, only about 50 mW of output power can be obtained within the generated ASE before self-lasing begins within TDF 12. By including pump isolator 20, it has been found that the output power level can be increased to about 170 mW without triggering any self lasing (the self lasing of certain optical modes is brought about by the creation of a resonance at one or more wavelengths, even in the absence of an input signal). It is also to be understood that in order to obtain incoherent emission that is evenly distributed within the ASE bandwidth, the generated output power needs to stay below the self-lasing threshold. ASE source 10 also includes a pair of isolators disposed along its signal path, shown here as a “back” isolator 24 and an output isolator 26, which are used to prevent parasitic reflections from re-entering TDF 12. Back isolator 24 is placed in the path of backward (co-pumped) emission, and protects TDF 12 from back reflections of the signal. Output isolator 26 is placed along the path of the forward (counter-pumped) emission, which is defined as the main output from ASE source 10, illustrated as ASEₒᵤₜ in FIG. 1.

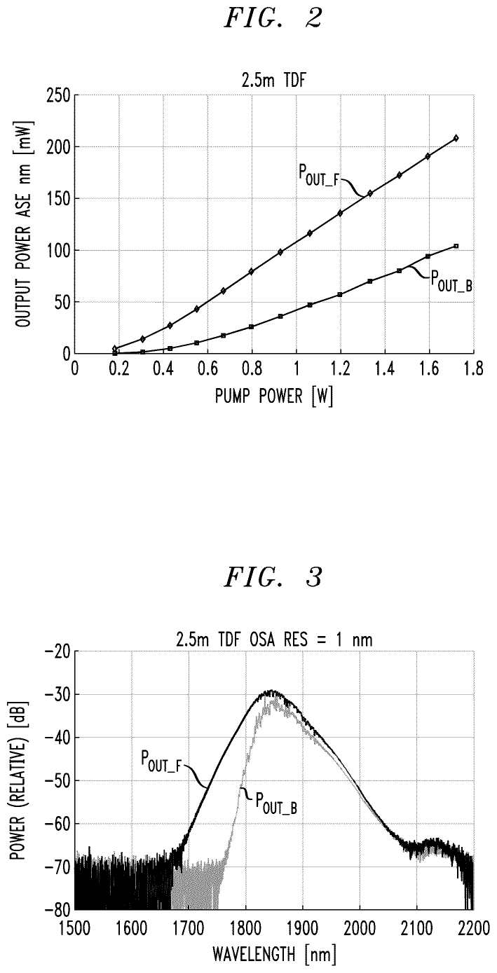

FIG. 2 shows the output ASE power as a function of pump power for source 10 of FIG. 1. Both the forward-directed output power (P_{out_F}) and the backward propagating output power (P_{out_B}) are plotted in FIG. 2, where the forward-directed power P_{out_F} is typically used as the main output from ASE source 10. As evident from the plots of FIG. 2, the power emitted in the forward direction is approximately twice as high as that in the backward direction for any given pump power. In the forward direction, P_{out_F} is shown to reach a level of about 200 mW for a pump source operating at a 1.7 W power level. When the pump power is increased above this level, the optical spectrum of the ASE may begin to exhibit self-lasing peaks associated with parasitic reflections back into TDF 12.

FIG. 3 shows a comparison of the ASE spectra associated with these forward and backward output directions. These spectra were generated within an arrangement of ASE source 10 that utilized a section of TDF 12 having a length on the order of about 2.5 meters, with the spectra exhibiting a center wavelength of about 1840 nm. The pump beam used to perform these measurements operated at a wavelength of 1567 nm, with a pump power of about 600 mW. By increasing or decreasing the length of TDF 12, the ASE center wavelength can be red-shifted or blue-shifted, respectively. The output power emitted in the backward direction is shown as being less symmetric than that of the forward-directed spectrum, and is also narrower on the short-wavelength side than the forward-directed ASE spectrum. The limitations in the back ASE spectrum can be attributed to the stronger reabsorption in TDF 12 of the emitted light.

It is to be understood that an arrangement similar to ASE source 10 of FIG. 1 may utilize a section of Ho-doped fiber (HDF), or alternatively a section of co-doped fiber (Tm-Ho) in place of TDF 12, where the wavelength of the pump beam is selected to initiate stimulated emission with the Ho ions in the fiber. For example, pump wavelengths of either 1860 nm or 1940 nm have been found to trigger spontaneous emission in HDF. One consideration in the selection of dopant is the wavelength range over which an ASE spectrum may be formed. In an Ho-doped embodiment, for example, the center wavelength of the ASE spectrum resides in the range of 2000-2200 nm (as compared to the 1700-1900 nm range for the Tm-doped configuration). Yet another alternative may be based on the use of Tm-Ho co-doped fiber, where the Tm ions are pumped at 1550 nm, and transfer their energy to the Ho ions, that then emit in the 1900-2200 nm wavelength band.

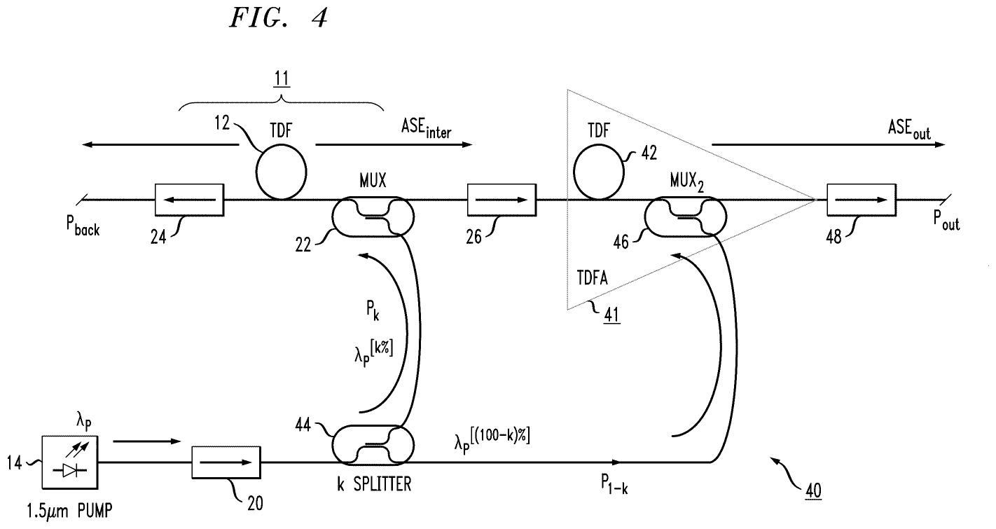

FIG. 4 illustrates another embodiment of the present invention, identified as ASE source 40. In this case, ASE source 40 can be thought of as an extension of ASE source 10 of FIG. 1; in particular with the addition of an amplifier stage 41 that is used to increase the output power of the ASE created within an ASE-generating stage 11. Elements of ASE 40 that are identical (substantially identical) to those of ASE 10 are identified by the same reference numerals. Here, however, the ASE output produced by the interaction of the pump beam and Tm-dopant within TDF 12 is identified as ASEᵢₙₜₑᵣ, an “inter-stage” ASE output.

As shown in FIG. 4, ASEᵢₙₜₑᵣ is thereafter applied as an input to amplifier stage 41 and in particular to a second section of TDF, referred to as TDF 42. In this embodiment, amplifier stage 41 can be thought of as a thulium-doped fiber amplifier (i.e., TDFA), where the input signal ASEᵢₙₜₑᵣ is amplified by an applied pump beam to impart additional gain to the created ASE and thereby produce a high-power ASE output.

In the particular embodiment of FIG. 4, pump source 14 is configured to be shared between ASE-generating stage 11 and amplifier stage 41. A power splitter 44 is shown as disposed at the output of pump isolator 20 (still required to prevent self-lasing reflections), and used to direct k % of the generated pump power (denoted Pₖ) as the input to WDM 22 and direct the remaining (100−k) % pump power (denoted P₁₋ₖ) as an input to amplifier stage 41 through WDM 46. (Alternatively, a pair of isolators 20.1 and 20.2 may be disposed along the output paths of power splitter 44.)

As shown in FIG. 4, WDM 46 is used to direct this second pump beam along the second section of TDF 42. It is to be understood that TDF 42 may be either counter-pumped, as shown in FIG. 4, or co-pumped. Inasmuch as counter-pumped arrangements are known to generate more output power, preferred embodiments of the present invention tend to use counter-propagating pumps for the amplifying stage of the ASE source. An output isolator 48 is preferably included to protect ASE source 40 from optical feedback reflections that could degrade the amplification process within TDF 42.

For optimal performance of ASE source 40, the splitting ratio of pump power splitter 44 needs to be selected to achieve maximum efficiency. That is, the percentage of power delivered to ASE-generating stage 11 needs to be sufficient to saturate the operation of TDF 12 in a manner that ultimately produces a high-power output across a wide bandwidth. However, the pump power applied to this stage needs to remain below the level that would otherwise trigger self-lasing, as discussed above.

At the same time, the remaining pump power fraction delivered to amplifier stage 41 needs to be high enough to deliver substantial amplification to applied input (ASEᵢₙₜₑᵣ), without triggering self-lasing in this stage. Different power fractions and designs can be simulated and evaluated to determine a best arrangement for a particular purpose. Alternatively, a pair of separate pump sources may be used (not shown), thereby eliminating the relationship between the pair of pump powers. When using two independent pump sources, the delivered power from each of them can be chosen to maximize the pump power applied to the doped fiber while operating below the self-lasing threshold for each stage. Moreover, the use of separate pump sources allows for a different dopant to be used as the gain fiber within amplifier stage 41. For example, a co-doped Tm-Ho single mode fiber could be used in place of TDF 42, and pumped with a second source operating at a suitable pump wavelength for this Tm-Ho co-doped fiber (e.g., a wavelength of 1567 nm).

If the various components forming ASE source 40 are polarization insensitive, then ASEₒᵤₜ will be randomly polarized, with its polarization evenly distributed along all angles. Alternatively, if optical isolator 26 is a polarization-dependent component, only a single, controlled polarization stage of the generated ASE will be presented as the input to amplifier stage 41.

A specific configuration of the embodiment shown in FIG. 4 may therefore utilize polarization-dependent components to deliver higher output powers of ASE, since essentially all of the created power will be directed into the restricted polarization state, typically linearly polarization. For this configuration, inter-stage isolator 26 comprises a polarization-dependent isolator that delivers a linearly polarized ASE spectrum as the input to PM amplifier stage 41. Here, TDF 42 is itself is formed of PM fiber and aligned with isolator 26 such that amplification occurs only along the polarization axis (e.g., the “slow” axis, also referred to as S-axis) of PM-TDF 42. Output isolator 48 is also preferably a polarization-dependent device, so that the generated high-power ASE is also linearly polarized. An important aspect of this particular configuration is that the light passing through the amplifying stage (i.e. PM-TDF 42) exhibits a linear SOP and extracts the power produced by PM-TDF 42 along the S-axis only.

Without polarization control, the light traveling through both TDF 12 and TDF 42 may amplify a random SOP and, as a result, the amplifying stage generates the light on both axes (i.e., the “slow” axis and “fast” axes of light propagation). When utilizing a polarized configuration including both a polarization-dependent inter-stage isolator 26 and PM fiber within amplifier stage 41, the output power is fully directed along the defined axis (the slow axis).

Another specific configuration of the two-stage ASE source as shown in FIG. 4 may be formed of double-clad Tm-doped fiber instead of single-clad fiber. The utilization of double-clad fiber as a doped fiber component allows for the pump beam to propagate within the inner cladding as well as the core region. By virtue of the propagation of a portion of the pump energy along the inner cladding, an optical combiner may be used instead of a WDM to control the propagation of both beams. Utilizing a section of double-clad fiber allows for the scaling of the output ASE power to multiwatt levels when pumped with a high-power multimode semiconductor laser pump source.

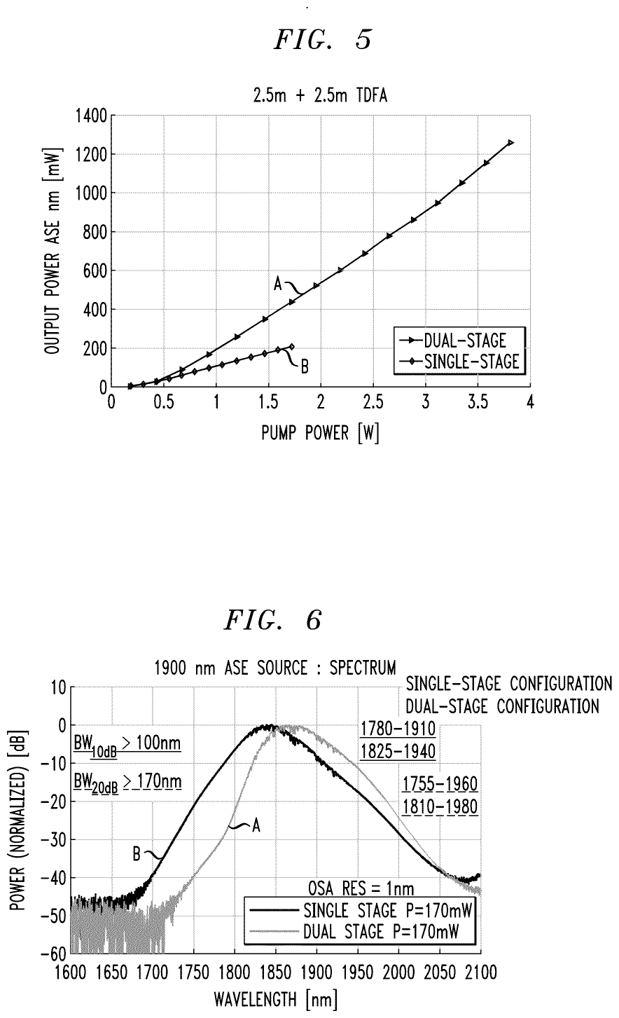

FIG. 5 is a graph of ASE output power as a function of applied pump power, where Plot A is associated with a particular configuration of ASE source 40 where power splitter 44 comprised a 25/75 split ratio. Plot B is associated with a single stage ASE source, such as ASE source 10 of FIG. 1. From this data, it is observed that for pump power levels above 1 W (generating ASE power >150 mW), the dual-stage ASE 40 of FIG. 4 is twice as efficient as single-stage ASE 10. Additionally, it is clear from plot A that an output power in excess of 1.2 W may be obtained from the dual-stage ASE 40 without introducing self-lasing. It is contemplated that even higher ASE output power levels may be obtained by using additional amplification stages. Also evident from this data is that the generation of ASE power in excess of 200 mW may require the use of a separate amplifier stage, such as amplifier stage 41 of ASE source 40.

FIG. 6 compares the produced ASE spectra for ASE sources 10 and 40. The ordinate axis defines “normalized” power in dB; namely the ratio of output ASE power to the peak ASE power (“peak” here being the power at the wavelength where the ASE emission is maximum). In both cases, the generated bandwidth of the ASE is greater than 170 nm (with particular reference to the 20-dB bandwidth cut-off). The peak wavelength for single-stage ASE source 10 is shown as being about 1830 nm, with the value of dual-stage ASE source 40 being closer to 1860 nm.

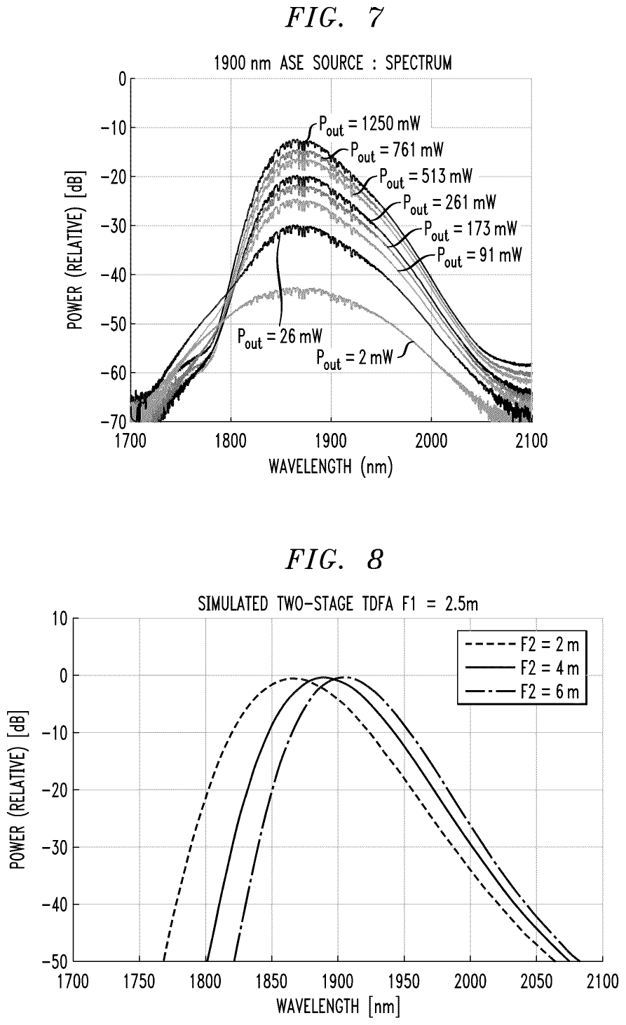

FIG. 7 shows the development of the ASE spectra as the output power is increased through several levels, ranging from a low of 2 mW to a high of 1.25 W as a function of an increase in delivered pump power. While the relative power levels are different, these results indicate that the ASE spectrum remains stable (and no self-lasing occurs) as the level of pump power is increased. It is observed that as the output power increases, the ASE bandwidth decreases, while the peak wavelength remains substantially the same (here, about 1860 nm).

It is known that various features of an ASE source are impacted by the length of doped fiber that is used. FIG. 8 shows simulation results associated with using three different lengths of fiber for TDF 42 of ASE source 40 (as shown in FIG. 4). For this demonstration, fiber lengths of 2 m, 4 m, and 6 m were chosen. The simulation results clearly show that as the fiber length is increased from 2 m to 6 m, the peak ASE wavelength shifts from 1830 nm to 1910 nm. Tuning of the desired peak wavelength for a particular application can therefore be achieved by controlling the length of the doped fiber used in the amplifying stage of the inventive ASE source.

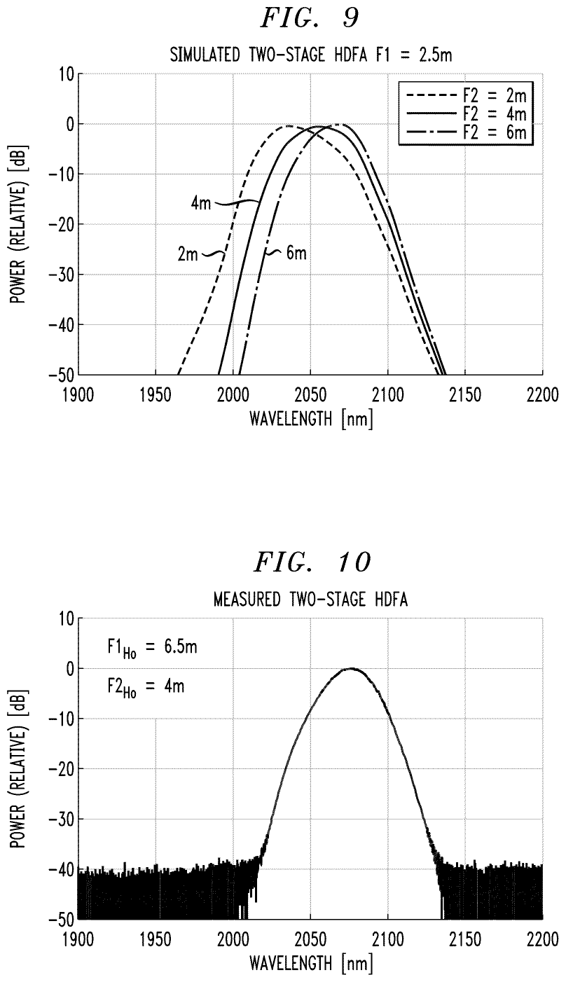

While dual-stage ASE source 40 of FIG. 4 is shown as comprising sections of Tm-doped optical fiber, a similar arrangement can be configured based upon the use of Ho-doped fibers. When forming a dual-stage ASE source of Ho-doped fiber (single clad), a pump beam operating at a pump wavelength λ_{P} of about 1900 nm is coupled into the core region of the HDF. As mentioned above, the use of sections of HDF allows for the generation of ASE spectra that are centered at a higher wavelength (i.e., in the range of 2000-2100 nm). As with the TDF-based version, changing the length of the amplifying fiber in an HDF-based arrangement provides for adjustment in the center wavelength of the generated ASE. FIG. 9 illustrates this change, again performing a set of simulations using the three doped fiber lengths of 2 m, 4 m, and 6 m as discussed above in associated with the Tm-based results shown in FIG. 8.

In the case of an HDF-based ASE source, changing the length of the amplifying fiber from about 2 m to 6 m allows for the peak ASE wavelength to be tuned within a range of about 2035-2070 nm. FIG. 10 shows measured results of an exemplary ASE spectrum based on the use of Ho-doped fibers in a two-stage arrangement. For these measurements, the Ho-doped fiber used in the ASE-generating stage was selected to have a length of 6.5 m, with Ho-doped fiber used in the amplifier stage was somewhat shorter (on the order of about of 4 m). In this case, the measured peak emission wavelength was about 2080 nm.

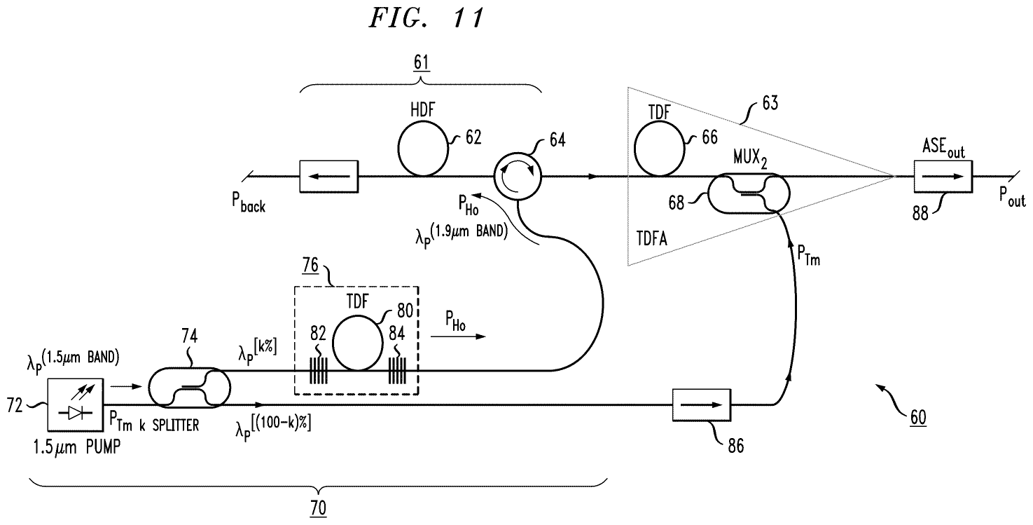

Yet another embodiment of the present invention is shown in FIG. 11, which may be referred to at times as a “hybrid” ASE source 60, with an ASE-generating stage 61 based on the use of Ho-doped fiber and an amplifier stage 63 that utilizes Tm-doped fiber. In this particular configuration, a fiber laser-based pump source 70 is configured to generate two pump beams at wavelengths appropriate for each type of fiber (as will be described in detail below).

Continuing with reference to hybrid ASE source 60 of FIG. 11, ASE-generating stage 61 is illustrated as including a section of Ho-doped fiber, referenced here as HDF 62. In this particular embodiment, HDF 62 receives its pump beam (P_{Ro}) input via an optical circulator 64. Advantageously, a circulator may take the place of a combination of a WDM and inter-stage isolator, as well as the pump isolator. As with the various embodiments described above, ASE is generated within HDF 62 by virtue of the presence of propagating pump beam P_{Ho} (denoted as ASEᵢₙₜₑᵣ in FIG. 11). ASEᵢₙₜₑᵣ is thereafter applied as an input to amplifier stage 63, and particularly to a section of Tm-doped fiber, referenced here as TDF 66. TDF 66 is preferably a single-clad fiber, with an appropriate pump beam P_{Tm} coupled via a WDM 68 into TDF 66 so as to propagate in a counter direction with respect to ASEᵢₙₜₑᵣ.

In this particular hybrid configuration, pump beam P_{Ho} needs to operate at a wavelength of about 1900 nm, and pump beam P_{Tm} at a wavelength of about 1550 nm. Single pump source 70, as mentioned above, is able to generate both of these pump beams. In particular, pump source 70 includes a first pump element 72 for creating pump beam P_{Tm} at a wavelength of 1550 nm. An arrangement such as pump source 14 shown in detail in FIG. 1 may be used for this purpose, and is considered as preferable inasmuch as the pump beam is generated with an “uncooled” arrangement (as opposed to using a semiconductor laser diode emitting at the desired wavelength, since the semiconductor device may be subject to thermally-induced center wavelength drifting and thus require temperature control).

Continuing with the description of pump source 70, the P_{Tm} beam output from first pump element 72 is thereafter applied as an input to a power splitter 74, which directs a first portion of the power into amplifier stage 63 (particularly as an input to a WDM 68) after passing through a pump isolator 86. The remaining power fraction output from power splitter 74 is coupled into a Tm-based fiber laser 76, which is able to use the remaining portion of P_{Tm} to generate as an output pump beam P_{Ho} operating within the 1900 nm region. In particular, Tm-based fiber laser 76 is shown as comprising a suitable length of Tm-doped fiber 80 disposed between a pair of reflective elements 82, 84 that are used to form the laser cavity. Careful choice of the parameters of fiber laser 76 allows it to create output pump beam P_{Ho} operating at about 1900 nm from an input (P_{Tm}) at a wavelength of about 1550 nm, As with the various embodiments described above, pump isolators 86 are included along both pump beam paths (shown in FIG. 11 as isolators 86.1 and 86.2) to reduce the likelihood of self-lasing occurring along either HDF 62 or TDF 66. An output isolator 88 is preferably included and positioned at the output of amplifier stage 63.

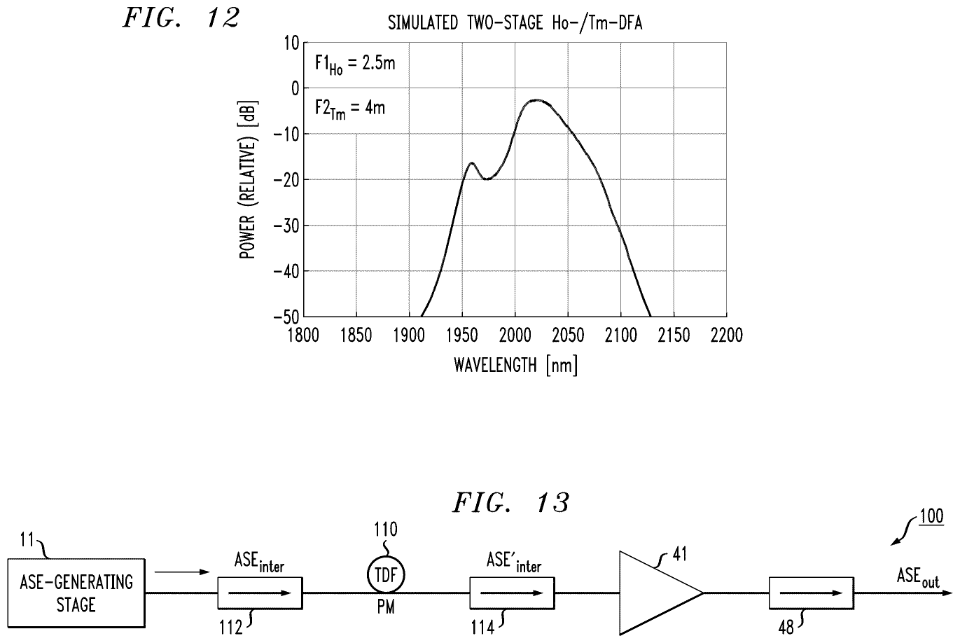

FIG. 12 shows a simulated output ASE spectrum for the hybrid embodiment of FIG. 11, in this case using a section of Ho-doped fiber having a length of 2.5 m and a section of Tm-doped fiber having a length of 4 m.

FIG. 13 illustrates yet another embodiment of the present invention. Referred to as ASE source 100, this configuration is similar to that of FIG. 4 and shows ASE-generating stage 11 and amplifier stage 41 in block diagram form. In this embodiment, an un-pumped section of Tm-doped fiber 110 is disposed between ASE-generating stage 11 and amplifier stage 41. TDF 110 preferably comprises a section of PM fiber, and is positioned between a pair of polarization-dependent optical isolators 112 and 114. The role of un-pumped TDF 110 is to broaden the spectrum of emission generated by stage 11 prior to injecting the emission into amplifier stage 41. As represented here, the ASEᵢₙₜₑᵣ output from ASE-generating stage 11 is broadened in bandwidth by passing through TDF 110, creating an output ASEᵢₙₜₑᵣ′ that is applied as an input to amplifier stage 41. A similar arrangement may be formed of HDFs (including an un-pumped section of HDF that is again preferably formed of PM fiber). It is contemplated that the lengths of unpumped fiber used for this purpose impact the amount of broadening that may be achieved, where it is to be noted that the spectral broadening is obtained at the expense of output power.

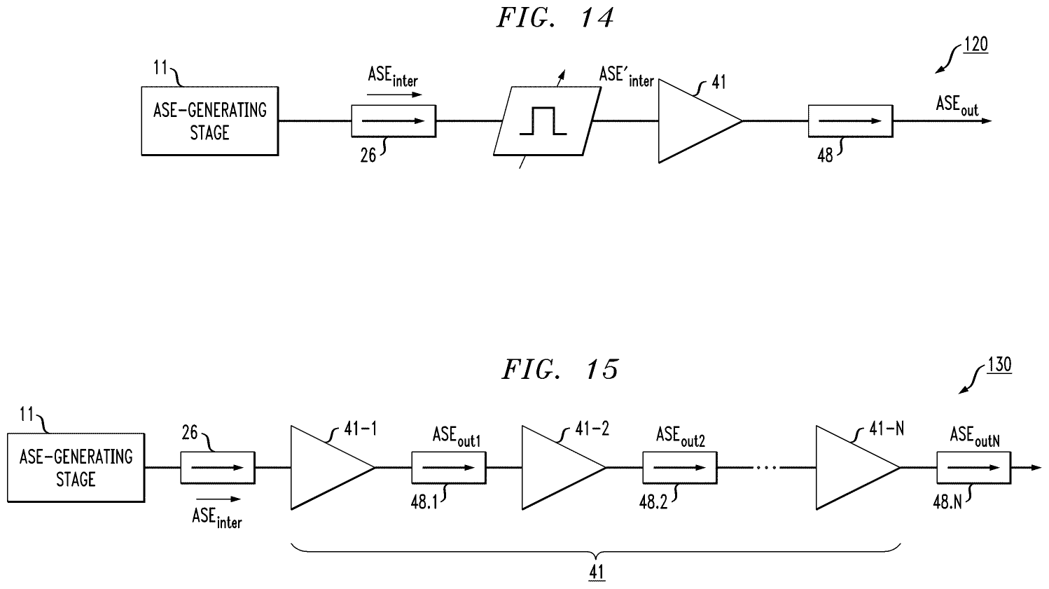

In some applications, it may be useful to shape the ASE spectrum to exhibit a particular profile (e.g., square, Gaussian, triangular, etc.). Additionally, controlling the wavelength range of the generated emission may be necessary. An embodiment of the present invention as shown in FIG. 14 is useful for this purpose. In particular, an ASE source 120 is configured to include a bandpass filter (BPF) 122 disposed between ASE-generating stage 11 and amplifier stage 41. The bandwidth of filter 122 can be configured to be anywhere in the range from a fraction of a nm (<<1 nm) to several nm (>>10 nm). The inclusion of filter 122 at this point along the signal path limits the ASE energy distribution and selects a certain portion of the ASE spectrum produced by ASE-generating stage 11 as the input for amplifier stage 41. As represented here, the ASEᵢₙₜₑᵣ output from ASE-generating stage 11 is filtered by passing through BPF 122, creating an output ASE_{fil} that is applied as an input to amplifier stage 41. By shaping the emission spectrum prior to amplification, the power generated within amplifier stage 41 is directed into only the usable bandwidth, thus forming an ASE source that exhibits more power over the defined bandwidth. Filter 122 may also extend the bandwidth of the ASE source by seeding a shorter wavelength band (e.g., 1760 nm) from ASE-generating stage 11 into amplifier stage 41. Filter 122 may be fixed or tunable across the amplified spectrum. Additionally, when used as a component of a polarization-maintaining ASE source, filter 122 is required to also maintain the desired polarization state. In a more general manner, filter 122 may take the form of an ASE WDM filter with N (N>2) outputs with some of different spectral widths that are used to seed some of the different amplifier stages.

It should be noted that while the various embodiments described above utilize a single amplifier stage, an ASE source formed in accordance with the principles of the present invention may also be used with a multi-stage amplifier as shown in block diagram form in FIG. 15. ASE source 130 of FIG. 15 is shown as based upon the same (or similar) ASE-generating stage 11 as described above, providing as an output ASEᵢₙₜₑᵣ. After passing through isolator 26, ASEᵢₙₜₑᵣ is applied as an input to a multi-stage amplifier 41, which consists of a cascaded arrangement of individual amplifier sections 41-1, 41-2, . . . , 41-N, separated by a set of optical isolators 48.1, 48.2, . . . , 48.N. Various arrangements of pump sources may be used with multi-stage amplifier 41, including the use of power splitters, individual pump sources, or any combination. By virtue of increasing the gain along each stage, a high-power ASE output is provided.

While certain preferred embodiments of the present invention have been illustrated and described in detail, it should be apparent that modifications and adaptations to these embodiments may occur to one skilled in the art without departing from the scope of the present invention as set forth in the claims appended hereto. Indeed, the described embodiments are to be considered in all respects as only illustrative and not restrictive.

What is claimed is:

1. An amplified spontaneous emission (ASE) source operating within the 2 μm region, comprising:
a first section of doped optical fiber containing a dopant selected from the group consisting of: Tm, Ho, and Tm-Ho;
a first pump source coupled to the first section of doped optical fiber and configured to provide a pump beam at a wavelength λ_{P} suitable for generating amplified spontaneous emission within the first section of doped optical fiber; and
a pump optical isolator disposed between the first pump source and the first section of doped optical fiber for blocking reflections and preventing self-lasing along the first section of doped optical fiber, permitting the generation of ASE having a high output power.

2. The ASE source as defined in claim 1 wherein the first pump source is disposed as a counter-propagating input to the first section of doped optical fiber, generating both a forward-directed ASE output and a backward-directed ASE output.

3. The ASE source as defined in claim 2 further comprising a pair of optical isolators coupled to opposite terminations of the first section of doped optical fiber.

4. The ASE source as defined in claim 1, further comprising:
a second section of doped optical fiber containing a dopant selected from the group consisting of: Tm, Ho, and Tm-Ho, the second section of doped optical fiber disposed beyond the output of the first section of doped optical fiber and responsive to a second pump beam; and
an ASE optical isolator disposed between the first and second sections of doped optical fiber, for preventing reflections from the second section of doped optical fiber from re-entering the first section of doped optical fiber and prevent an initiating of self-lasing within the ASE source.

5. The ASE source as defined in claim 4 wherein the first section of doped optical fiber is included within an ASE-generating stage for generating an initial ASE signal, and the second section of doped optical fiber is included within an amplifier stage for increasing the output power of the initial ASE signal.

6. The ASE source as defined in claim 2, further comprising a pump power splitter disposed beyond the output of the first pump source and used to provide as separate outputs the first pump beam and the second pump beam.

7. The ASE source as defined in claim 4, further comprising a separate, second pump source for generating the second pump beam.

8. The ASE source as defined in claim 1 wherein the first pump source comprises a fiber laser.

9. The ASE source as defined in claim 7 wherein either one or both of the first and second pump sources comprises a fiber laser.

10. The ASE source as defined in claim 4 wherein the ASE optical isolator comprises a polarization-dependent optical isolator and the second section of doped optical fiber comprises polarization-maintaining optical fiber.

11. The ASE source as defined in claim 4, further comprising an optical bandpass filter disposed between the first and second sections of doped optical fiber, limiting an ASE spectrum provided as an input to the second section of doped optical fiber.

12. The ASE source as defined in claim 11 wherein the optical bandpass filter comprises a fixed bandwidth filter.

13. The ASE source as defined in claim 11 wherein the optical bandpass filter comprises a filter with a tunable bandwidth within the 2 μm region.

14. The ASE source as defined in claim 4, further comprising a section of unpumped doped fiber disposed between the first section of doped optical fiber and the second section of doped optical fiber, the section of unpumped doped fiber extending a bandwidth of the ASE signal generated within the first section of doped optical fiber.

15. The ASE source as defined in claim 4, further comprising at least one additional section of doped optical fiber disposed in series beyond the second section of doped optical fiber, the at least one additional section of doped optical fiber responsive to a pump beam and used to increase an optical power of the generated ASE prior to exiting the ASE source.

16. The ASE source as defined in claim 4 wherein the second section of doped optical fiber comprises a section of double-clad optical fiber.

17. The ASE source as defined in claim 4, wherein the first and section sections of doped optical fiber use different dopants to create a hybrid ASE source.

18. The ASE source as defined in claim 17, wherein the first section of doped optical fiber comprises Ho-doped optical fiber, creating ASE output using a first pump beam at a first pump wavelength λ_{Ho}, and the second section of doped optical fiber comprises Tm-doped optical fiber, imparting optical output power to the created ASE output using a second pump beam at a second pump wavelength λ_{Tm}.

19. The ASE source as defined in claim 18, further comprising a separate pump source for generating the second pump beam at λ_{Tm}.

20. The ASE source as defined in claim 18 wherein the pump source comprises
a first fiber laser for generating an output at the second pump wavelength λ_{Tm};
an optical power splitter disposed at the output of the first fiber laser and used to form a pair of separate outputs including a first pump beam output having a first fraction of the created power and a second pump beam output having a remaining fraction of the created power;
a first optical isolator disposed along the first pump beam output, the output from the first optical isolator provided as the second pump beam at the second wavelength λ_{Tm} to the second section of doped optical fiber;
a second fiber laser coupled to the second pump output of the optical power splitter, the second fiber laser receiving as an output the second pump beam at the second pump wavelength λ_{Tm} and generating therefrom the first pump beam operating at the first pump wavelength λ_{Ho}; and
a second optical isolator disposed between the output of the second fiber laser and the first section of doped optical fiber.

21. The ASE source as defined in claim 20 wherein the first fiber laser includes a section of Er—Yb co-doped optical fiber, providing as an output the second pump beam at a wavelength of λ_{Tm}.

22. The ASE source as defined in claim 21 wherein the second fiber laser includes a section of Tm-doped optical fiber, providing as an output the first pump beam at a wavelength of λ_{Ho}.
